(19) United States
(12) Patent Application Publication
(10) Pub. No.: US 2019/0145938 A1
(43) Pub. Date: May 16, 2019

(54) DEVICE AND METHOD FOR MEASURING AT LEAST ONE PARAMETER OF A TREATMENT FLUID IN A SURFACE TREATMENT SYSTEM

(71) Applicant: EISENMANN SE, Böblingen (DE)

(72) Inventor: Apostolos Katefidis, Gärtringen (DE)

(21) Appl. No.: 16/098,156

(22) PCT Filed: Apr. 6, 2017
(86) PCT No.: PCT/EP2017/058244

§ 371 Date: Nov. 1, 2018

(30) Foreign Application Priority Data
May 4, 2016 (DE) 10 2016 005 371.2

(51) Int. Cl. G01N 29/22; G01N 29/02

(52) U.S. Cl. CPC G01N 29/222; G01N 2291/0423; G01N 2291/02416; G01N 29/02

(57) ABSTRACT

A device for measuring at least one parameter of a treatment fluid in a surface treatment system, having an acoustic surface wave measurement device, which has a measurement chamber, which delimits a measurement volume for the treatment fluid, and converters for acoustic surface waves, which are arranged on the measurement chamber, and is designed to provide at least one measurement output signal, which is dependent on the current state of the treatment fluid in the measurement volume, using the converters. The device has an evaluation unit having a time progression recording device which is designed to record the temporal progression of the at least one measurement output signal of the acoustic surface wave measurement device, and a parameter determination device, which is designed to determine the value of the at least one parameter to be measured from the recorded temporal progression of the measurement output signal of the acoustic surface wave measurement device.

### BACKGROUND TO THE INVENTION

### 1. Field of the Invention

The invention relates to a device and a method for measuring at least one parameter of a treatment fluid in a surface treatment system and to an immersion treatment system and a method for treating objects that make use of this measurement.

### 2. Description of the Prior Art

An acoustic surface wave measurement device in which the properties of a medium flowing through a pipe segment are measured with the aid of acoustic surface waves that are guided along a pipe segment from one converter for acoustic surface waves to another converter for acoustic surface waves is known from WO 2010/136350 A1. The fundamental principle of such an SAW measurement is based on the fact that a portion of the energy of the generated acoustic surface waves is coupled into the medium, so that volume sound waves are generated in the medium. These volume sound waves in turn couple into the pipe segment, whereby acoustic surface waves are again generated. Chemical and/or physical properties of the medium can be determined through the measurement and evaluation of specific characteristics of the acoustic surface waves that are again captured at the receiver, such as for example their speed of travel or their amplitudes. Reference is made explicitly to the content of WO 2010/136350 A1 for details of the principle of an acoustic surface wave measurement device.

General acoustic sound wave measurement devices which couple the sound waves directly into the medium furthermore exist.

The fact that in the case, for example, of a mixture of more than two components in one medium, no clear conclusions can be derived as to the mixing ratio is, however, disadvantageous for the prior art described there, in particular when applied to an immersion treatment fluid in immersion treatment systems.

### SUMMARY OF THE INVENTION

The object of the invention is therefore to further develop the measurement devices referred to above in terms of their evaluation possibilities, in order to permit their use for the measurement of parameters of a treatment fluid in surface treatment systems.

This is achieved according to the invention by a device for the measurement of at least one parameter of a treatment fluid in a surface treatment system, in which
a) an acoustic sound wave measurement device which has
   a measurement chamber which delimits a measurement volume for the treatment fluid, and
   converters for acoustic sound waves, which are arranged on the measurement chamber, and
   is designed, using the converters, to provide at least one measurement output signal, which is dependent on the current state of the treatment fluid in the measurement volume,
b) an evaluation unit having
a time progression recording device which is designed to record the temporal progression of the at least one measurement output signal of the acoustic sound wave measurement device, and
a parameter determination device, which is designed to determine the value of the at least one parameter to be measured from the recorded temporal progression of the measurement output signal of the acoustic sound wave measurement device,
   is provided.

The inventor has recognized that further information can be determined from the measurement method using acoustic sound waves if the fluid to be measured is given the opportunity for the components contained therein to at least partially separate under the influence of gravity or centrifugal force, and if the measurement is repeated during the separation process. This is because the gradient that develops in respect of various components during the separation within the measurement volume influences the signal propagation and thereby also the result of the acoustic sound wave measurement, i.e. the measurement output signal of the acoustic sound wave measurement device. Conclusions can be drawn as to different compositions through the recording of the temporal progression of the measurement output signal and subsequent evaluation of the temporal progression, since the various components have different separation rates. A strong separation or sedimentation takes place in particular in the case of solid-fluid mixtures such as the treatment fluid in immersion treatment systems, as a result of the markedly different densities of solids and liquids.

The measurement of a parameter thus follows a two-stage concept, in which the acoustic sound wave measurement method itself is applied in the known manner, and the change of this measurement result during a separation process is observed and evaluated in order to determine the desired parameter.

A very wide range of physical and/or chemical parameters such as the pH value, paint proportion, binding agent proportion, temperature etc. come into question here as the parameter of the treatment fluid to be measured.

The evaluation unit can be an independent component, or may, however, also be integrated together with the acoustic sound wave measurement device. Preferably the evaluation unit is implemented at least in part as a software solution which can be executed, for example, on a standard commercial computer and which receives the measurement output signal from the acoustic sound wave measurement device through appropriate interfaces such as USB or signal recording cards.

Preferably the acoustic sound wave measurement device is an acoustic surface wave measurement device, and the converters for acoustic sound waves are accordingly converters for acoustic surface waves. An acoustic surface wave measurement device has been found to be particularly suitable for treatment fluids.

Advantageously, the parameter determination device can comprise a comparison device which is designed to compare the recorded temporal progression of the at least one measurement output signal with reference progressions that are stored in a database. The reference progressions can be generated previously through the measurement of treatment fluids in which one and/or a plurality of parameters have different values. The reference progressions can also here be present in parameterized form, i.e. the fact that for example the measurement output signal must rise or fall with a predetermined reference gradient in order for a particular value of a parameter to be measured which is assigned to the actually measured progression to be stored in the database.

The evaluation in the parameter determination device can, however, also determine the value of the at least one parameter using a wide range of evaluation algorithms directly from the measured temporal progression, without referring to reference progressions determined previously. The parameter determination device can comprise an expert system for this purpose or also for the comparison with the reference progressions.

Means are preferably provided for introducing, holding and removing the treatment fluid into and from the measurement chamber. These can, for example, be pumps and/or valves for removing the treatment fluid, for example out of the immersion bath of an immersion treatment system in online operation.

A controller is preferably provided which is designed to actuate the means for introducing, holding and removing the treatment fluid into and from the measurement chamber in such a way that the treatment fluid remains in the measurement volume for a predetermined period of time. Sufficient separation can in this way take place in the measurement volume.

The predetermined period of time should preferably here be at least long enough for a measurable change to result in the temporal progression of the at least one measurement output signal as a result of a separation in the treatment fluid. A measurable change then occurs, for example, when the comparison device and/or the expert system of the parameter determination device can determine the at least one parameter on the basis of the change in the temporal progression.

Advantageously the means for introducing, holding and removing are arranged in such a way that the treatment fluid is introduced into the measurement chamber from below. Any sediment which may be present can in this way be flushed out better when refilling for the subsequent measurement. Advantageously the measurement chamber can also be connected to a container of the surface treatment system in which flushing fluid is maintained for flushing out the measurement chamber.

Preferably the measurement chamber has greater dimensions in the vertical direction than in the horizontal direction. The greatest possible height of the measurement volume in comparison to its width results in a better separation. The measurement chamber can therefore be a tube extending in a vertical direction, at the upper and lower ends of which respectively converters for acoustic sound waves, in particular surface waves, are arranged.

Preferably the time progression recording device is designed to record a plurality of different measurement output signals of the acoustic sound wave measurement device. Since an acoustic sound wave measurement device can output measurement output signals which represent different properties of the surface wave measurement, further information for determining the parameters of the actual measurement apparatus can be extracted from the temporal progression of these different measurement output signals. Thus for example the measurement output signals of the sound waves and/or surface wave measurement can be used for the amplitude attenuation for different wave group signals such as 1WG, 2WG and 3WG etc. The measurement output signal can be at least one of the following groups: amplitude of the surface wave (pure propagation over the measurement chamber), amplitude of the first wave group (single crossing of the fluid), amplitude of the second wave group (crossing the fluid twice), group velocity of the surface wave in the measurement volume, speed of sound of the fluid. If the converters are reversible converters, the above measurement output signals can therefore be output both for the one and for the other direction.

Preferably the parameter determination device is also designed to compare the temporal progressions of a plurality of different measurement output signals with respective reference progressions. It may optionally be possible in this way to determine yet more parameters of the treatment fluid, or for an individual parameter to be determined more accurately. The parameter determination device here performs an appropriate n-dimensional evaluation.

Advantageously the parameter determination device is designed to determine the composition of the treatment fluid in terms of at least three components as the parameter to be measured. Although with an SAW measurement the temperature, for example, of the treatment fluid can be determined from the speed of sound, the measurement of the composition is of particular interest, since this is crucial for the result of the treatment, and because other measurement sensors are available for a parameter such as the temperature. It has in particular been found for treatment fluid in immersion treatment systems that, with an acoustic surface wave measurement device, the ratio of binding agent, paste (paint particles) and deionized water can be determined by evaluating the temporal progression of the amplitude of the first wave group (single crossing of the fluid) as the measurement output signal, since this signal exhibits a sufficiently strong change behavior in the course of the separation.

According to another aspect of the invention, a surface treatment system for the treatment of objects, in particular vehicle bodywork or parts thereof, in a treatment fluid is provided, wherein the immersion treatment system comprises a device according to the invention for the measurement of at least one parameter of the treatment fluid. In this way, in the case of an immersion treatment system for example, an online parameter recording can be established in order to regulate the parameters of the treatment fluid for an optimum treatment.

According to another aspect of the invention, a method is provided for the measurement of at least one parameter of a treatment fluid in a surface treatment system, comprising the following steps:
a) introducing the treatment fluid into a measurement chamber of an acoustic sound wave measurement device, wherein the treatment fluid is initially in a homogeneous, mixed condition;
b) recording a temporal progression of a measurement output signal of the acoustic sound wave measurement device while the treatment fluid is held in the measurement chamber and the components contained therein continue to separate;
c) determining the parameter to be measured from the temporal progression of the measurement output signal.

Advantageously the acoustic sound wave measurement device here is an acoustic surface wave measurement device.

The determination of the parameter to be measured from the temporal progression of the measurement output signal preferably comprises the comparison of the recorded progression with stored reference progressions.

According to another aspect of the invention, a method for the treatment of objects, in particular of vehicle bodywork or parts thereof, in a treatment fluid is provided wherein at least one parameter of the treatment fluid is monitored by measurement using a measurement method according to the invention while the objects are being treated.

### SHORT DESCRIPTION OF THE DRAWINGS

Exemplary embodiments of the invention are explained in more detail below with reference to the drawings. Here:

FIG. 1 shows a schematic illustration of an immersion treatment system with an acoustic surface wave measurement device for the determination of the properties of a treatment fluid;

FIG. 2 shows a schematic illustration of the acoustic surface wave measurement device, including the wave signals that occur in that connection;

FIG. 3a shows a schematic illustration of the treatment fluid in the acoustic surface wave measurement device at the start of the measurement according to the invention;

FIG. 3b shows a schematic illustration of the treatment fluid in the acoustic surface wave measurement device during the measurement according to the invention;

FIG. 3c shows a schematic illustration of the treatment fluid in the acoustic surface wave measurement device at the end of the measurement according to the invention;

FIG. 4 shows a diagram of a recorded temporal progression of a measurement output signal of the acoustic surface wave measurement device;

FIG. 5 shows diagrams of reference progressions and recorded progressions for the purposes of explaining the parameter determination through comparison.

### DESCRIPTION OF PREFERRED EXEMPLARY EMBODIMENTS

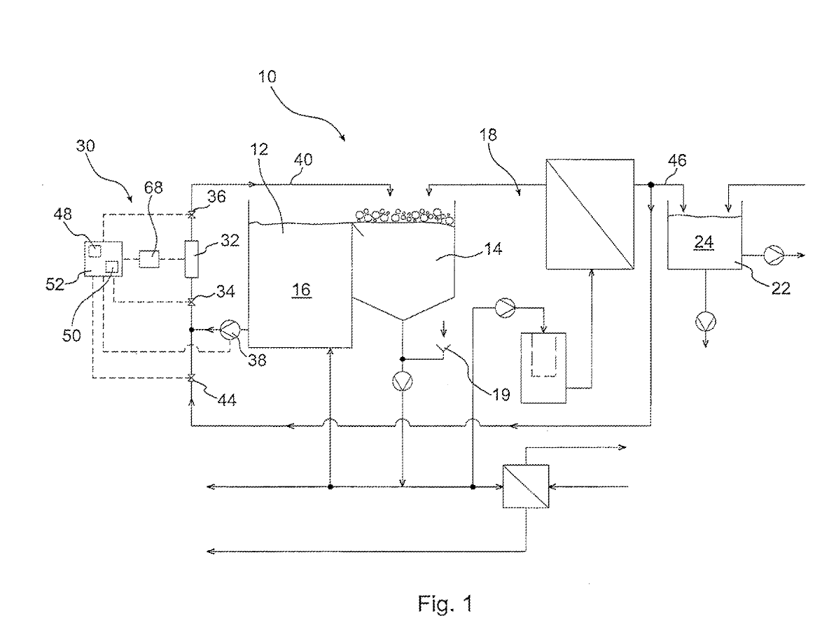

FIG. 1 shows an immersion treatment system, identified as a whole with 10, for objects to be treated such as vehicle bodywork or parts thereof. The immersion treatment system 10 comprises an immersion bath 12 with an overflow bath 14 in which an immersion treatment fluid 16, which is typically composed of a large number of components, is held.

In order to control various physical and/or chemical parameters of the immersion treatment fluid 16, in particular its composition in terms of pH value, paint proportion, binding agent proportion, temperature etc. during the immersion treatment process, the immersion bath 12 is integrated by way of the overflow bath 14 into a conditioning circuit 18 known as such from, for example, DE 10 2014 006 795 A1 and not to be described in more detail for the immersion treatment fluid 16. Substances can be added to and/or removed from the immersion treatment fluid 16 at an inlet 19 with the aid of the conditioning circuit 18. Substances can be added or removed here manually by the operator, or this may also be done partially and/or fully automatically.

As can furthermore be seen in the right-hand part of FIG. 1, a flushing bath 22 is shown schematically, in which flushing fluid 24 is located which can be used in a rear section of the immersion treatment system 10, for example for flushing objects that have already been treated.

A measurement device 30 for the measurement of various physical and/or chemical parameters of the immersion treatment fluid 16 is arranged schematically on the left in FIG. 1 positioned next to the immersion bath 12.

For this purpose, the measurement device 30 comprises a vertical pipe segment 32 as a measurement chamber, at the inlet of which a valve 34 and at the outlet of which a valve 36 are located. A pump 38 precedes the inlet-side valve 34, and is in turn connected to the immersion bath 12. The pipe segment 32 of the measurement device 30 can in this way be filled with immersion treatment fluid 16 from the immersion bath 12 when the valve 34 is open and the pump 38 is actuated. Since the inlet to the pipe segment 32 is arranged at the bottom end in the vertical sense, filling takes place from below.

At the output end the pipe segment 32 is connected through the valve 36 and the return line 40 to the overflow bath 14, so that the immersion treatment fluid 16 can be returned to it after the measurement.

The pipe segment 32 is connected at the inlet end via a flushing line 42 and a valve 44 to a pressure inlet 46 to the flushing bath 22 for this purpose. With the aid of this flushing line 42 the pipe segment 32 can, when needed, be flushed with the aid of the flushing fluid 24, whereby the immersion treatment fluid 16 that has already been measured is removed from the pipe segment 32.

For actuation of these processes, the measurement device 30 has a controller 48, which here is realized, together with an evaluation unit 50, in a conventional PC 52, and connected to the valves 34, 36, 44 and to the pump 38.

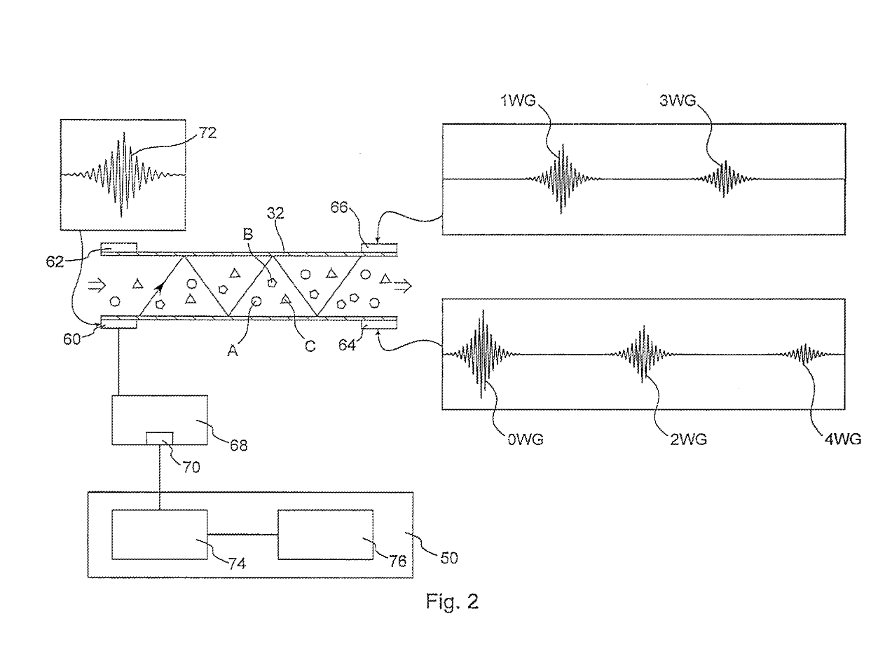

As can be seen from FIG. 2, at the pipe segment 32 the measurement device 30 here comprises by way of example four converters for acoustic surface waves, which are identified at the input end with reference signs 60 and 62 and at the output end with reference signs 64 and 66. The converters 60, 62, 64 and 66 are connected to an SAW evaluation system 68 which performs both the actuation and the evaluation of the converter signals, and which provides various measurement output signals which depend on the condition of the immersion treatment fluid in the pipe segment 32 at its digital output 70.

The SAW evaluation system 68 can, for example, couple an excitation signal 72 in at the converter 60. This travels in part along the pipe segment 32 itself, and is received by the converter 64 as the first wave group signal 1WG. Another part of the excitation signal 72 couples into the immersion treatment fluid 16 in the measurement volume, and crosses this in the direction of converter 66. It is then received there as the second wave group signal 2WG. One evaluation option of the SAW evaluation system 68 can now for example consist in determining the time delay between the wave group signal 1WG and the wave group signal 2WG, in order to deduce from this the speed of sound in the immersion treatment fluid 16. The value of the speed of sound can then be output at the digital output 70.

Reference is made to the already cited document WO 2010/136350 A1 for possible SAW evaluation methods, since the details of the SAW evaluation are not relevant for the present invention. This is because the pipe segment 32, the converters 60, 62, 64 and 66 and the SAW evaluation system 68 here represent an acoustic surface wave measurement device which can be integrated into the measurement arrangement 30 as a black box component. The SAW evaluation system 68 can, however, also of course be realized together with the controller 48 and the evaluation unit 50 in the PC 52, and optimized for the measurement purposes that are present.

Exemplary measurement output signals MS that are output at the acoustic surface wave measurement device can be: the amplitude of the surface wave 0WG from converter 60 to converter 64, which corresponds to a pure propagation along the pipe segment 32; the amplitude of the surface wave from converter 64 to converter 60, which corresponds to a pure propagation along the pipe segment 32; the amplitude of the first wave group 1WG from converter 60 to converter 66, which corresponds to a single crossing of the fluid 16; the amplitude of the first wave group from converter 66 to converter 60, which corresponds to a single crossing of the fluid; the amplitude of the second wave group 2WG from converter 60 to converter 64, which corresponds to crossing the fluid 16 twice; the amplitude of the second wave group 2WG from converter 64 to converter 60, which corresponds to crossing the fluid 16 twice; the group velocity of the surface wave in the pipe segment 32; the speed of sound of the fluid 16; the amplitude of the nth wave group, which corresponds to crossing the fluid 16 n times.

As can furthermore be seen from FIG. 2, the SAW evaluation system 68 is connected to a time progression recording device 74 of the evaluation unit 50, which records the values of the measurement output signals MS provided at the digital output 70, and stores them in a memory.

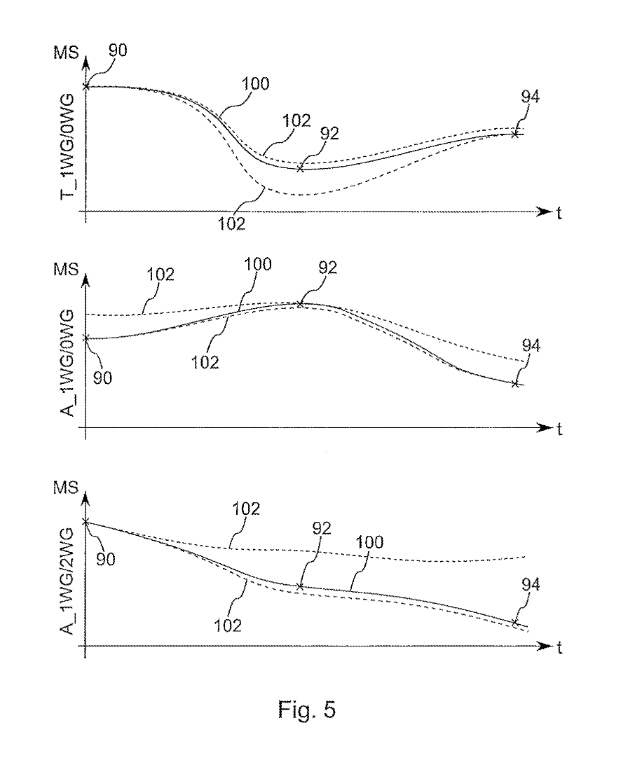

The evaluation unit 50 furthermore comprises a parameter determination device 76 which accesses the memory of the time progression recording device 74 and its own database in order to compare the measured temporal progression 100 of a measurement output signal with reference progressions 102 (see FIGS. 4 and 5). The evaluation unit in this way determines a predetermined parameter as a result of the measurement of the measurement arrangement 30.

The measurement apparatus 30 works as follows:

If, for example, a measurement of the composition of the immersion treatment fluid 16 is to take place, the controller 48 thus opens the inlet valve 34 and, with the aid of the pump 38, conveys immersion treatment fluid 16 into the pipe segment 32.

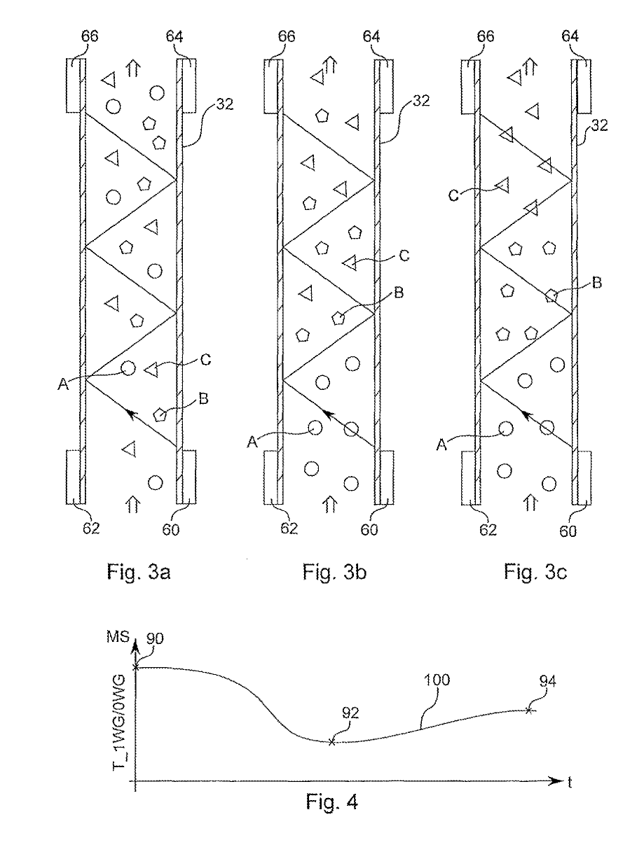

The situation in the pipe segment 32 immediately after the inlet valve 34 has been closed is as shown in FIG. 3a. The here exemplary components A (circle), B (pentagon), C (triangle) are distributed in a homogeneous mixture in the pipe segment 32.

With the aid of the converters 60, 62, 64 and 66, the SAW evaluation system 68 couples acoustic surface waves into the measurement volume, where they are influenced by the non-homogeneously mixed immersion treatment fluid 16. The result of the SAW evaluation is then supplied as a first value 90 of the measurement output signal to the time progression recording device (cf. FIG. 4).

Since the inlet valve 34 still remains closed, the immersion treatment fluid 16 settles in the pipe segment 32, and a sedimentation effect occurs as a result of gravitational force, so that the components A, B, C partially separate. This is suggested in FIG. 3b by the collection of the denser component A in the lower region of the pipe segment 32. A new SAW measurement with the aid of the acoustic surface wave measurement device supplies a second value 92 for the recorded progression (cf. FIG. 4) which differs from the first value 90 as a result of the partial separation.

After a further period of time, the immersion treatment fluid 16 has separated further. A further SAW measurement supplies a third value 94.

During the period in which the immersion treatment fluid 16 remains in the pipe segment 32, a real measurement device 30 will perform a large number of SAW measurements, since the SAW measurements take place quickly in comparison with the sedimentation.

As is suggested in FIG. 5, the progression 100 recorded in this way is then compared with previously recorded reference progressions 102 which have been recorded for defined compositions of the immersion treatment fluid 16. The measured composition then corresponds to the composition whose reference progression 102 has the greatest similarity to the recorded progression 100.

In detail, the comparison can take place by means of an expert system which is based on known classification algorithms. In particular, a plurality of recorded progressions of different measurement output signals MS of the acoustic surface wave measurement device 68 can be compared with associated reference progressions, wherein existing correlations that permit a comprehensive evaluation can be taken into account. This is suggested by the two lower diagrams in FIG. 5, which show the progression 100 for other measurement output signals MS and the associated reference progressions 102.

The evaluation unit 50 can in this way determine a large number of different parameters of the immersion treatment fluid 16.

What is claimed is:

1. A device for measuring at least one parameter of a treatment fluid in a surface treatment system, comprising:
a) an acoustic sound wave measurement device which
has a measurement chamber which delimits a measurement volume for a treatment fluid, and
has converters for acoustic sound waves, which are arranged on the measurement chamber, and
is designed, using the converters, to provide at least one measurement output signal, which is dependent on the current state of the treatment fluid in the measurement volume, and
b) an evaluation unit comprising
a time progression recording device which is designed to record temporal progression of the at least one measurement output signal of the acoustic sound wave measurement device, and
a parameter determination device, which is designed to determine a value of at least one parameter measured from the recorded temporal progression of the measurement output signal of the acoustic sound wave measurement device.

2. The device as claimed in claim 1, wherein the acoustic sound wave measurement device is an acoustic surface wave measurement device, and the converters for acoustic sound waves are converters for acoustic surface waves.

3. The device as claimed in claim 1, wherein the parameter determination device (76) comprises a comparison device which is designed to compare the recorded temporal progression (100) of the at least one measurement output signal (MS) with reference progressions (102) that are stored in a database.

4. The device as claimed in claim 1, wherein the parameter determination device (76) comprises an expert system.

5. The device as claimed in claim 1, wherein means (34, 36, 38) for introducing, holding and removing the treatment fluid (16) are provided in the measurement chamber (32).

6. The device as claimed in claim 5, wherein a controller (48) is provided which is designed to actuate the means (34, 36, 38) for introducing, holding and removing the treatment fluid (16) into and from the measurement chamber (32) in such a way that the treatment fluid (16) remains in the measurement volume for a predetermined period of time.

7. The device as claimed in claim 6, wherein the predetermined period of time is at least long enough that a measurable change results in the temporal progression of the at least one measurement output signal (MS) as a result of the separation in the treatment fluid (16).

8. The device as claimed in claim 1, wherein claims, characterized in that the means (34, 36, 38) for introducing, holding and removing are arranged in such a way that the treatment fluid (16) is introduced into the measurement chamber (32) from below.

9. The device as claimed in claim 1, wherein the measurement chamber (32) has larger dimensions in the vertical direction than in the horizontal direction.

10. The device as claimed in claim 1, wherein the time progression recording device (74) is designed to record a plurality of different measurement output signals (MS) of the acoustic sound wave measuring device (68).

11. The device as claimed in claim 1, wherein the parameter determination device (76) is designed to compare the temporal progressions (100) of a plurality of different measurement output signals (MS) with respective reference progressions (102).

12. The device as claimed in claim 1, wherein the parameter determination device (76) is designed to determine the composition of the treatment fluid (16) in terms of at least three components (A, B, C) as the parameter to be measured.

13. An immersion treatment system (10) for the treatment of objects in a treatment fluid comprising the device for the measurement of at least one parameter of treatment fluid as claimed in claim 1.

14. A method for measuring at least one parameter of a treatment fluid of a surface treatment system, the method comprising the following steps:
a) introducing a treatment fluid into a measurement chamber of an acoustic sound wave measurement device, wherein the treatment fluid is initially in a homogeneous, mixed condition;
b) recording a temporal progression of a measurement output signal of the acoustic sound wave measurement device while the treatment fluid is held in the measurement chamber and the components contained therein continue to separate;
c) determining a parameter to be measured from the temporal progression of the measurement output signal.

15. The method for treating objects of claim 14, wherein at least one parameter of the treatment fluid is monitored by measurement while objects are being treated.
